(19) United States
(12) Patent Application Publication
(10) Pub. No.: US 2010/0109426 A1
(43) Pub. Date: May 6, 2010

(54) Portable control device for wireless communication with air brake line airflow manipulating device

(76) Inventors: Robert V. Fugiel, Cary, IL (US); Robert C. Fletcher, SR., Barrington, IL (US); Robert C. Fletcher, JR., Cary, IL (US)

Correspondence Address: Carmen Patti Law Group , LLC, ONE N. LASALLE STREET, 44TH FLOOR, CHICAGO, IL, 60602, US

(21) Appl. No.: 12/592,122

(22) Filed: Nov. 19, 2009

Related U.S. Application Data
(63) Continuation of application No. 11/408,748, filed on Apr. 21, 2006, now abandoned.

(51) Int. Cl. B60T 13/74; G01L 5/28

(52) U.S. Cl. 303/3; 73/121

(57) ABSTRACT

An apparatus in one example comprises an airflow manipulating device, a portable control device, and an air pressure sensor. The airflow manipulating device is disposed between a source of compressed air and an air brake line of a train consist. The portable control device is in wireless communication with the airflow manipulating device. The portable control device is transportable by a user along the train consist during inspection of the air brake line. The portable control device is adapted to transmit a control signal over a wireless communication channel to move a valve in the airflow manipulating device to a position that causes an increase or decrease of air pressure in the air brake line. The air pressure sensor measures an air pressure level in the air brake line for wireless transmission to the portable control device.

### TECHNICAL FIELD

The invention relates generally to air brake testing and more particularly to remote control of an air pressure reduction test of a railroad air brake line.

### BACKGROUND

A Federal Railroad Administration regulation (49 CFR §232.12) requires an air pressure reduction test of an air brake line of a train consist upon occurrence of various specified events. For example, when performed at the time the train consist is originally made up, the air pressure reduction test is known as the initial terminal inspection. The air pressure reduction test is performed to determine whether the brakes apply on each car of the train consist in response to a twenty pounds per square inch (“PSI”) brake line pressure reduction.

One known method of performing the air pressure reduction test requires a person to be physically located near one or more valves that control the flow of air into or out of the air brake line. At a first time, that person moves a valve into a position that allows air to enter the air brake line from a source of compressed air. At a later time, after the air pressure level in the air brake line reaches a predetermined level (such as around ninety PSI), that person moves a valve into a position that allows a release of air from the air brake line to reduce the air pressure in the air brake line by twenty PSI.

After the air brake line has been charged to the predetermined level and before the twenty PSI release, a person walks the length of the train consist to inspect the air brake line for any leaks. After the twenty PSI release, a person walks the length of the train consist again to check that the brakes have applied on each car. In one example, the person who physically moves the valves is the same person who walks the length of the train consist to inspect the air brake line. As one shortcoming of this an arrangement, that person must walk the length of the train consist at least four times to perform the air pressure reduction test. In another example, one person physically moves the valves and another person walks the train consist to inspect the air brake line. As one shortcoming of this arrangement, multiple people are needed to perform the air pressure reduction test. Because of the considerable labor involved, it is desirable to remotely control the air pressure reduction test. However, the ability to remotely control the air pressure reduction test in prior attempts has been limited.

Thus, a need exists for improved control of an air pressure reduction test of an air brake line of a train consist.

### SUMMARY

The invention in one implementation encompasses a system. The system comprises an airflow manipulating device, a portable control device, and an air pressure sensor. The airflow manipulating device is disposed between a source of compressed air and an air brake line of a train consist. The portable control device is in wireless communication with the airflow manipulating device. The portable control device is transportable by a user along the train consist during inspection of the air brake line. The portable control device is adapted to transmit a control signal over a wireless communication channel to move a valve in the airflow manipulating device to a position that causes an increase or decrease of air pressure in the air brake line. The air pressure sensor measures an air pressure level in the air brake line for wireless transmission to the portable control device.

Another implementation of the invention encompasses a system. The system comprises a portable control device for wireless communication with an airflow manipulating device disposed between a source of compressed air and an air brake line of a train consist. The portable control device is transportable by a user along the train consist during inspection of the air brake line. The portable control device is adapted to transmit a control signal over a wireless communication channel to move a valve in the airflow manipulating device to a position that causes an increase or decrease of air pressure in the air brake line. The portable control device is adapted to receive and display a measurement of an air pressure level in the air brake line.

Yet another implementation of the invention encompasses a system. The system comprises a portable control device in communication with an airflow manipulating device over a wireless communication channel. The airflow manipulating device disposed between a source of compressed air and an air brake line of a train consist, the airflow manipulating device comprising: a valve responsive to a first control signal transmitted by the portable control device over the wireless communication channel to the airflow manipulating device, wherein the first control signal causes the valve to move into a partially open position that allows a release of air from the air brake line; a pressure sensor that measures an air pressure level in the air brake line while the valve is in the partially open position; and a sending device that transmits the air pressure level measurement over the wireless communication channel to the portable control device. The portable control device transmits a second control signal over the wireless communication channel to the airflow manipulating device to further open the valve, provided that a rate of air pressure reduction in the air brake line, while the valve is in the partially open position, is below a predetermined rate of air pressure reduction.

Still another implementation of the invention encompasses a method. A first control signal is transmitted over a wireless communication channel to move a valve into a partially open position to perform an air pressure reduction test of an air brake line of a train consist. An air pressure level measurement is received corresponding to an air pressure level in the air brake line while the valve is in the partially open position. A second control signal is transmitted over the wireless communication channel to further open the valve, provided that a rate of air pressure reduction in the air brake line, while the valve is in the partially open position, is below a predetermined rate of air pressure reduction.

### DESCRIPTION OF THE DRAWINGS

Features of exemplary implementations of the invention will become apparent from the description, the claims, and the accompanying drawings in which:

FIG. 1 is a representation of one implementation of a system that comprises an airflow manipulating device in communication with a portable control device for remote control of the airflow manipulating device to perform an air pressure reduction test of an air brake line of a train consist.

FIGS. 2-4 are representations of various positions for a main valve and a reduction valve in the airflow manipulating device of the system of FIG. 1.

FIG. 5 is a representation of one implementation of the internal components of the airflow manipulating device of the system of FIG. 1.

FIG. 6 is a representation of one implementation of a valve motor drive for a valve in the airflow manipulating device of the system of FIG. 1.

FIG. 7 is a representation of one implementation of a pressure sensor interface in the airflow manipulating device of the system of FIG. 1.

FIG. 8 is a representation of one implementation of a temperature and voltage interface in the airflow manipulating device of the system of FIG. 1.

FIG. 9-13 are representations of various display pages presented on the portable control device of the system of FIG. 1.

FIG. 14 is a representation of a logic flow that illustrates an interaction between the portable control device and the airflow manipulating device to activate the system of FIG. 1.

FIG. 15 is a representation of a logic flow that illustrates an interaction between the portable control device and the airflow manipulating device to open the main valve of the airflow manipulating device of the system of FIG. 1.

FIG. 16 is a representation of a logic flow that illustrates an interaction between the portable control device and the airflow manipulating device to close the main valve of the airflow manipulating device of the system of FIG. 1.

FIG. 17 is a representation of a logic flow that illustrates an interaction between the portable control device and the airflow manipulating device to open the reduction valve of the airflow manipulating device of the system of FIG. 1.

FIG. 18 is a representation of a logic flow that illustrates an interaction between the portable control device and the airflow manipulating device to close the reduction valve of the airflow manipulating device of the system of FIG. 1.

### DETAILED DESCRIPTION

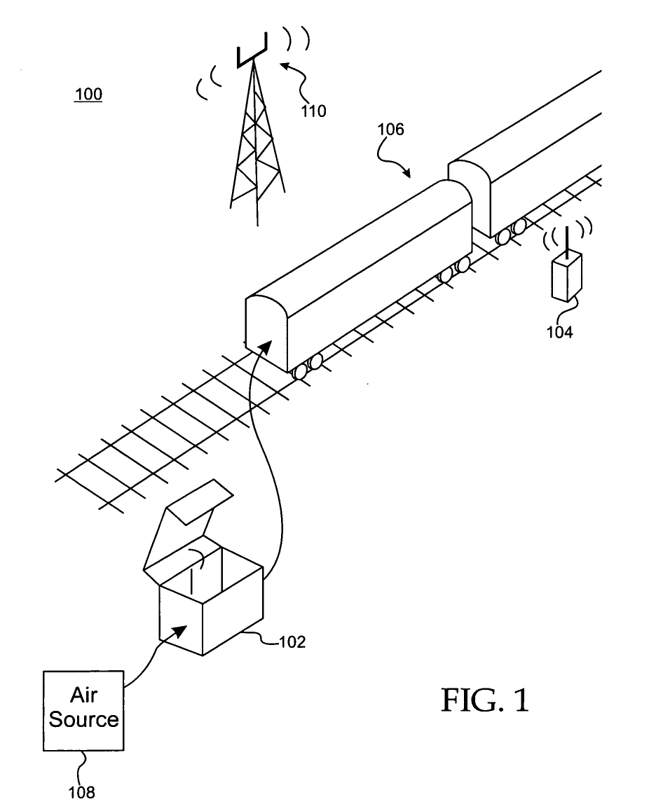

Turning to FIG. 1, a system 100 in one example comprises an airflow manipulating device 102 in communication with a portable control device 104 for remote control of the airflow manipulating device 102 to perform an air pressure reduction test of an air brake line of a train consist 106. The train consist 106 comprises a cut of one or more railroad cars connected along an air brake line. The air pressure reduction test in one example is performed to determine whether the brakes apply on each of the railroad cars along the air brake line in response to a twenty pounds per square inch (“PSI”) pressure reduction in the air brake line, as stated in the Federal Railroad Administration regulations (49 CFR §232.12). In addition to remotely controlling the air pressure reduction test, the portable control device 104 in one example can also determine whether the leakage in the air brake line is greater than five PSI per minute, as stated in the Federal Railroad Administration regulations (49 CFR §232.12). The airflow manipulating device 102 is disposed between a source of compressed air 108 and the air brake line of the train consist 106 to be able to cause an increase or decrease of air pressure in the air brake line. The source of compressed air 108 in one example comprises a stand alone air compressor or an air compressor on a locomotive.

In one example, the airflow manipulating device 102 and the portable control device 104 communicate directly. In another example, the airflow manipulating device 102 and the portable control device 104 communicate through one or more repeaters 110. The repeater 110 receives and forwards wireless transmissions between a transceiver associated with the portable control device 104 and a transceiver associated with the airflow manipulating device 102. For longer range transmissions, the repeater 110 may be used to maintain an acceptable signal strength level along the communications path. If the train consist 106 is relatively short, then the airflow manipulating device 102 and the portable control device 104 may communicate directly. However, if the train consist 106 is relatively long, then the airflow manipulating device 102 and the portable control device 104 may communicate through one or more repeaters 110. The repeater 110 in one example is located in a central area of the rail yard. The repeater 110 may be located on a tower at a desired elevation. The repeater 110 in one example is mounted on a tower at an elevation of one hundred feet above ground level.

The airflow manipulating device 102 and the portable control device 104 send signals to each other over wireless communication channels. The wireless communication channels in one example comprise dedicated data channels. For example, the signals sent on the dedicated data channels do not interfere with radio voice transmissions. The airflow manipulating device 102 and the portable control device 104 in one example send the signals on a citizen's band radio frequency using specially coded frequency shift keying methodologies so as to not interfere with other signals. For example, the signals are coded such that cross-talk between channels or with other railroad communications systems is eliminated. Therefore, only signals relating to a specific railroad track or train consist will be recognized by the airflow manipulating device 102 and the portable control device 104 used for that specific railroad track or train consist. The airflow manipulating device 102 and the portable control device 104 are uniquely keyed to act only on the proper commands. The keying system prevents signals generated for a train consist on one track from interfering with signals generated for a train consist on an adjacent track.

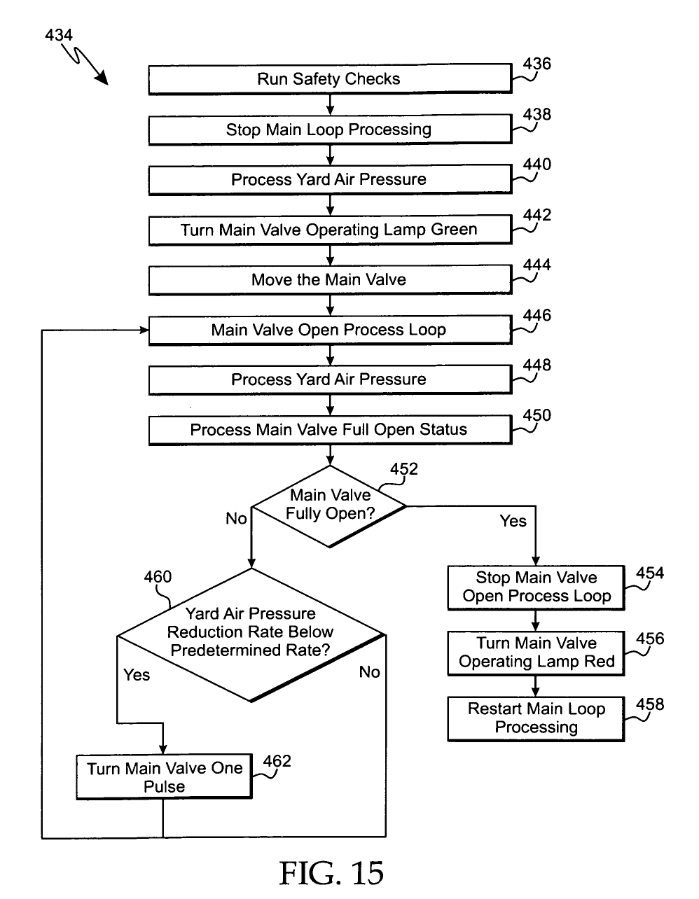

Referring to FIGS. 1-4, the airflow manipulating device 102 in one example comprises an interface 202 with the source of compressed air 108, an interface 204 with the air brake line of the train consist 106, a main valve 206, a reduction valve 208, and a reduction orifice 210. A first air line connects the source of compressed air 108 to the interface 202 of the airflow manipulating device 102. A second air line connects the air brake line to the interface 204 of the airflow manipulating device 102. The portable control device 104 remotely controls the main valve 206 and the reduction valve 208 to regulate the air pressure level in the air brake line of the train consist 106. For example, the portable control device 104 sends control signals over a wireless communication channel to the airflow manipulating device 102 to move the main valve 206 and the reduction valve 208 between various positions to cause an increase or decrease of the air pressure level in the air brake line, as will be described herein with reference to FIGS. 15-18. In one example, the main valve 206 and the reduction valve 208 are separate valves. In another example, the functionalities of the main valve 206 and the reduction valve 208 are combined into a single valve.

In response to the control signals received from the portable control device 104, the airflow manipulation device 102 transmits acknowledgement messages back to the portable control device 102. For example, where the portable control device 102 sends a control signal to instruct the airflow manipulation device 102 to perform a task, the airflow manipulation device 102 sends an acknowledgement message back to the portable control device 102 to indicate completion of the task.

The main valve 206 and the reduction valve 208 are independently controllable to place the airflow manipulation device 102 into one of a plurality of states. In one example, the airflow manipulation device 102 is in a first state where air can flow between the source of compressed air 108 and the air brake line of the train consist 106 but not out the reduction orifice 210. In another example, the airflow manipulation device 102 is in a second state where the air in the air brake line is isolated from the source of compressed air 108 and the reduction orifice 210. In yet another example, the airflow manipulation device 102 is in a third state where the air in the air brake line is isolated from the source of compressed air 108 but can be released out the reduction orifice 210.

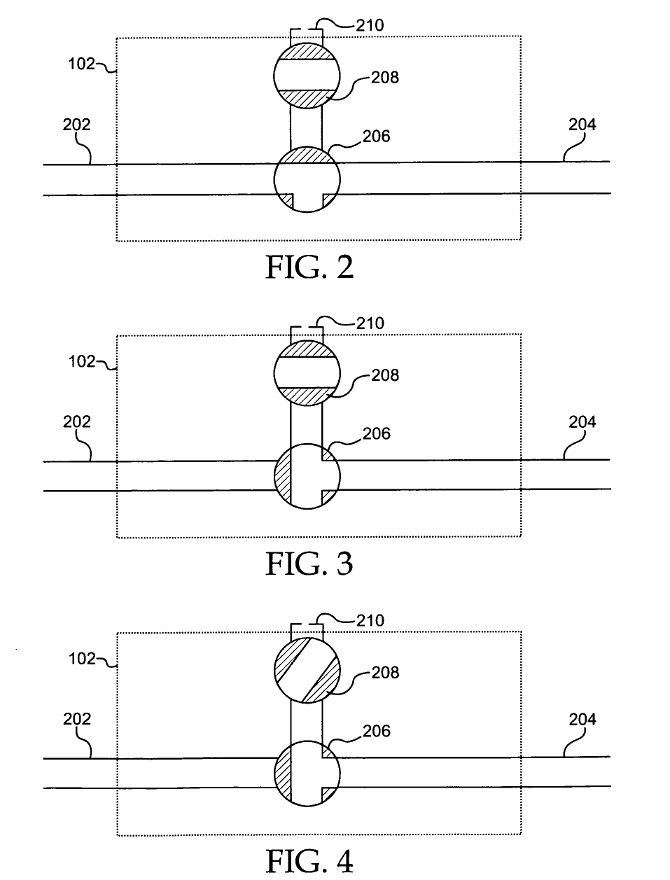

Referring to FIG. 2, the main valve 206 is shown in a position that allows passage of air from the source of compressed air 108 to the air brake line of the train consist 106. While the main valve 206 is in this position, the source of compressed air 108 can charge the air brake line of the train consist 106 to a predetermined air pressure level (such as around ninety PSI). After the air brake line reaches the predetermined air pressure level, the main valve 206 can be moved into a position that blocks the flow of air between the air brake line and the source of compressed air 108.

Referring to FIG. 3, the main valve 206 is shown in a position that blocks the flow of air between the air brake line and the source of compressed air 108. While the main valve 206 is in this position, the air pressure level of the air brake line may be monitored to determine if the air brake line has a leak. During this monitoring period, the reduction valve 208 is in a closed position that prevents a release of air pressure from the air brake line out the reduction orifice 210. Once the air pressure level in the air brake like is determined to be satisfactory while the air brake line is isolated from the source of compressed air 108, then the air brake line is ready for the air pressure reduction test. To reduce the air pressure level in the air brake line, the reduction valve 208 is moved to a position that allows a release of air from the air brake line out the reduction orifice 210. The reduction orifice 210 in one example comprises a ¼ inch opening.

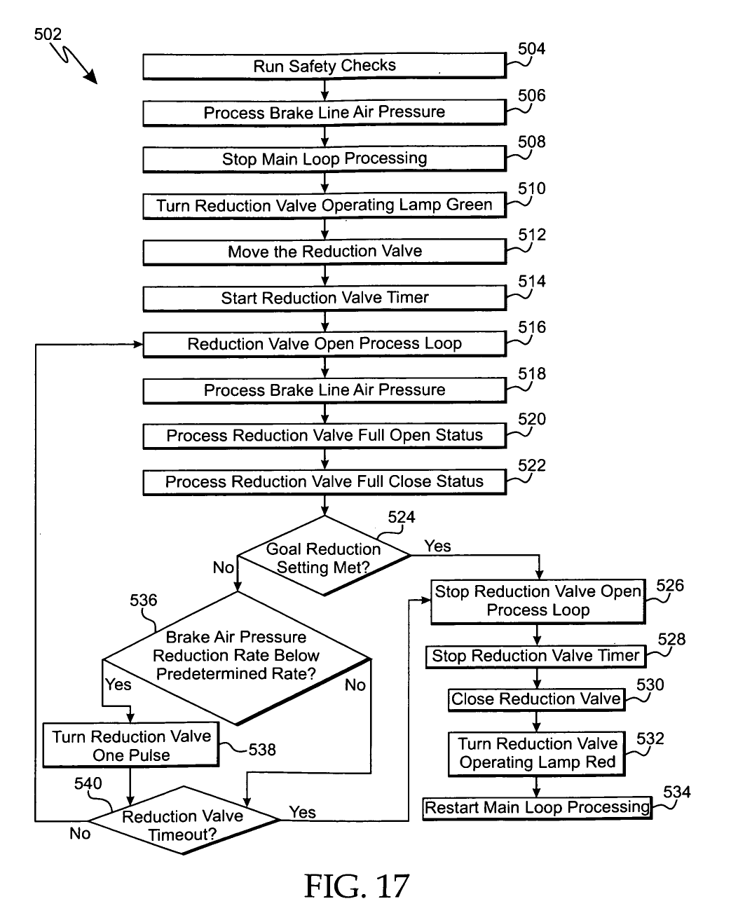

Referring to FIG. 4, the reduction valve 208 is shown in a position that allows a release of air from the air brake line out the reduction orifice 210. To allow release of air from the air brake line, the reduction valve 208 may in any one of a plurality of open positions. The plurality of open positions allow differing amounts of air to be released from the air brake line. In one example, the reduction valve 208 may be moved to a first partially open position that allows a first rate of air pressure reduction in the air brake line. In another example, the reduction valve 208 may be moved to a second partially open position that allows a different rate of air pressure reduction in the air brake line. The amount that the reduction valve 208 is open for the air pressure reduction test in one example depends on a desired rate of air pressure reduction for the air brake line, as will be described herein with reference to FIG. 17.

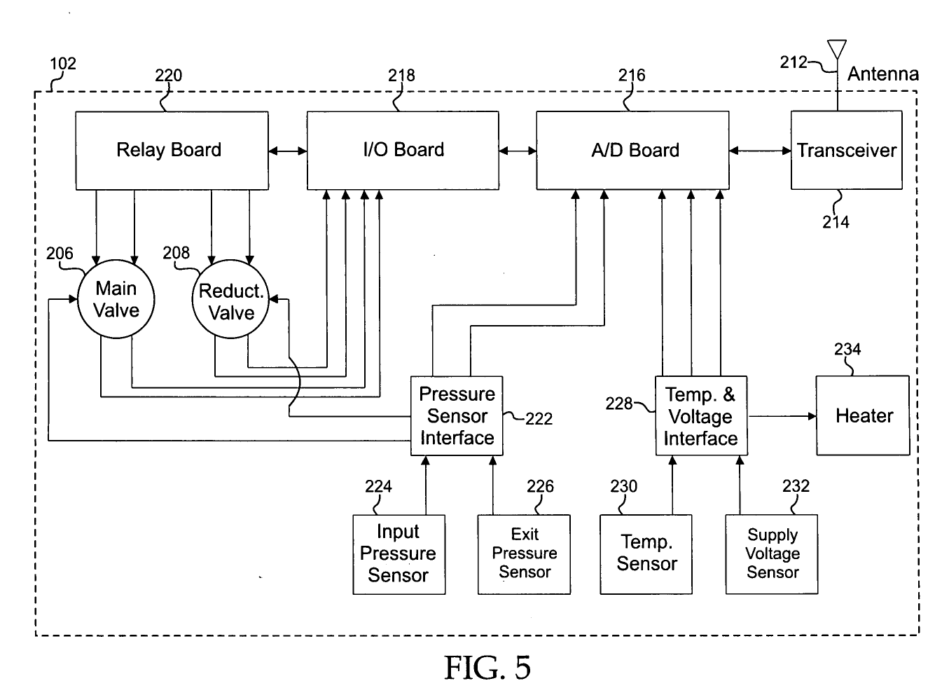

Referring to FIGS. 1 and 5, the airflow manipulating device 102 comprises the main valve 206, the reduction valve 208, an antenna 212, a transceiver 214, an analog-to-digital (“A/D”) converter 216, an input/output (“I/O) board 218, a relay board 220, a pressure sensor interface 222, an input air pressure sensor 224, an exit air pressure sensor 226, a temperature and voltage interface 228, a temperature sensor 230, a supply voltage sensor 232, and a heater 234.

An illustrative description of one operation of the airflow manipulating device 102 is now presented, for explanatory purposes. The transceiver 214 employs the antenna 212 to receive control signals from the portable control device 104. A control signal received from the portable control device 104 in one example instructs the airflow manipulating device 102 to move either the main valve 206 or the reduction valve 208 into a different position. The transceiver 214 passes the control signal to the relay board 220. If the control signal instructs the airflow manipulating device 102 to move the main valve 206 to a different position, then the relay board 220 activates a valve motor drive associated with the main valve 206. If the control signal instructs the airflow manipulating device 102 to move the reduction valve 208 to a different position, then the relay board 220 activates a valve motor drive associated with the reduction valve 208. The active valve motor drive system then sends information related to the new position of the main valve 206 or the reduction valve 208 to the I/O board 218. The I/O board 218 passes the valve position information to the transceiver 214 for wireless transmission to the portable control device 104.

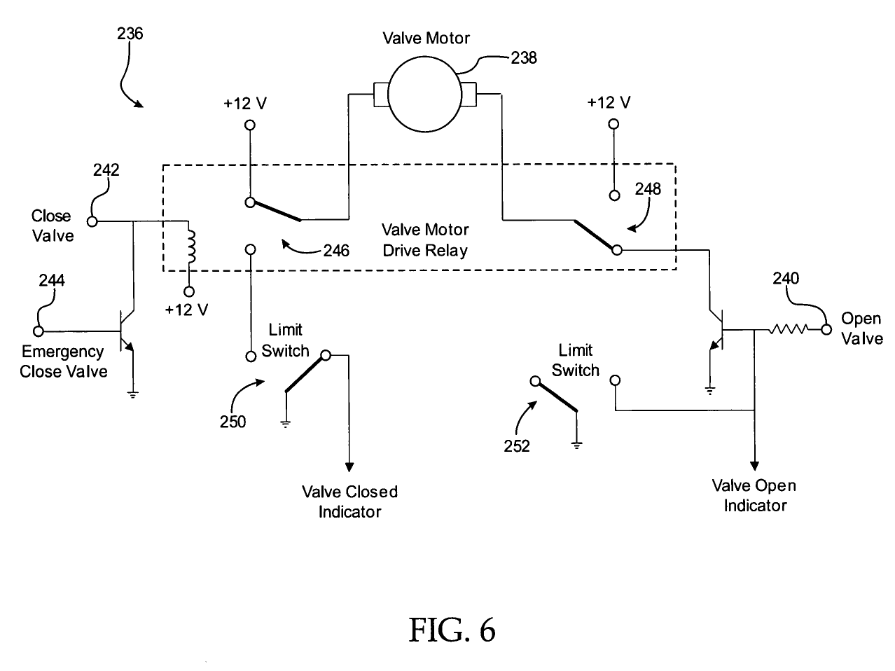

Referring to FIGS. 5 and 6, an illustrative description of one operation of a valve motor drive 236 is now presented, for explanatory purposes. The valve motor drive 236 in one example comprises a valve motor 238, an open valve node 240, a close valve node 242, an emergency close valve node 244, drive relay switches 246 and 248, and limit switches 250 and 252. The main valve 206 and the reduction valve in one example are electronically actuated valves. The valve motor drive 236 serves to move a valve between positions. The valve motor drive 236 also provides valve position signals to the I/O board 218 for wireless transmission to the portable control device 104. For example, the valve motor drive 236 comprises a valve closed indicator and a valve open indicator. The valve motor drive 236 shown in FIG. 6 could be used for either the main valve 206 or the reduction valve 208. The airflow manipulating device 102 in one example comprises two instances of the valve motor drive 236; one used to drive the main valve 206 and one used to drive the reduction valve 208.

FIG. 6 illustrates the valve motor drive 236 in a configuration that corresponds to a valve in a fully closed position. For example, the valve motor drive 236 is ready to open the valve in response to a positive signal applied to the open valve node 240. When a positive signal is applied to the open valve node 240, the valve motor 238 drives the valve open for the length of time the positive signal is placed on the open valve node 240. Depending on the duration of the positive signal, the valve drive pulse may only partially open the valve or further open the valve by a small amount. Applying a plurality of sequential drive pulses to the open valve node 240 serves to incrementally open the valve associated with the valve motor drive 236. In one example, the positive signal may be applied to the open valve node 240 for twenty milliseconds and then the valve motor 238 drives open the valve for twenty milliseconds. In another example, the positive signal may be applied to the open valve node 240 for three seconds and then the valve motor 238 drives open the valve for three seconds. A short drive pulse results in the valve motor 238 opening the valve by a smaller amount than when a longer drive pulse is applied to the open valve node 240.

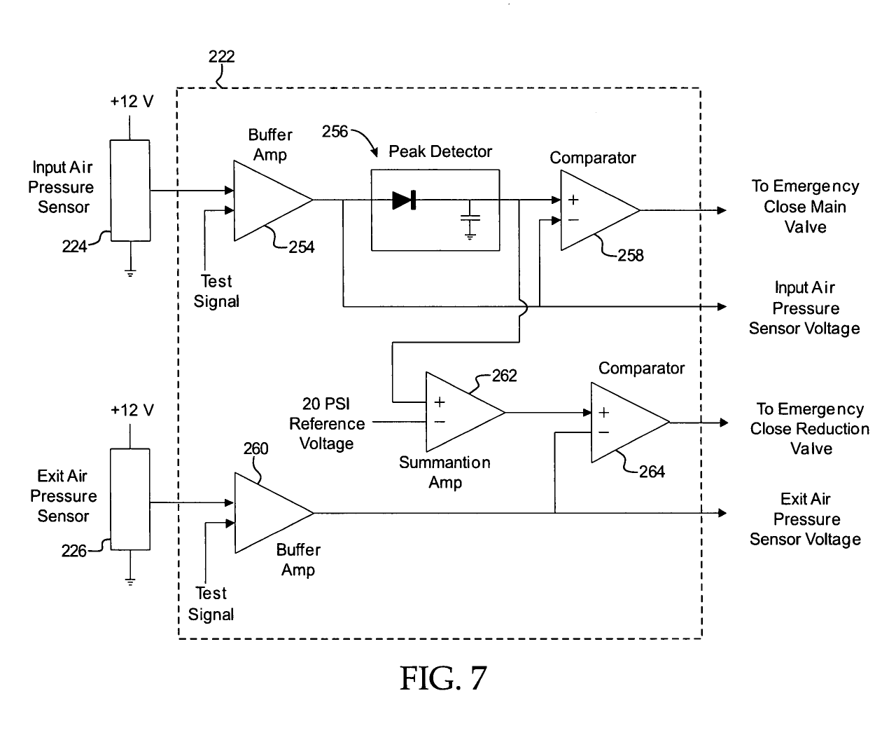

To close the valve that is associated with the valve motor drive 236, a ground signal is placed on close valve node 242 and the drive relay switches 246 and 248 are moved to the opposite positions than those that are shown in FIG. 6. When a ground signal is applied to the close valve node 242, the valve motor 238 drives the valve closed for the length of time the ground signal is placed on the closed valve node 242. For example, the ground signal may be applied to the close valve node 242 for three seconds and then the valve motor 238 drives open the valve for three seconds. Another way to close the valve that is associated with the valve motor drive 236 is to use the emergency close valve node 244, as will be described herein with reference to FIG. 7. When a positive signal is applied to the emergency close valve node 244, the valve motor 238 drives the valve closed for the length of time the positive signal is placed on the emergency close valve node 244.

Referring to FIGS. 5 and 7, an illustrative description of one operation of the pressure sensor interface 222 is now presented, for explanatory purposes. The pressure sensor interface 222 receives air pressure inputs from the input air pressure sensor 224 and the exit air pressure sensor 226. The input air pressure sensor 224 essentially measures an air pressure level of the source of compressed air 108 (the “yard” air pressure level). For example, the input air pressure sensor 224 is located on an air line that connects the source of compressed air 108 to the airflow manipulating device 102. The exit air pressure sensor 226 essentially measures an air pressure level in the air brake line of the train consist 106. For example, the exit air pressure sensor 226 is located on an air line that connects the airflow manipulating device 102 to the air brake line. The input air pressure sensor 224 and the exit air pressure sensor 226 in one example are located inside of a housing of the airflow manipulating device 102.

The pressure sensor interface 222 comprises a buffer amplifier 254, such as a unity gain buffer, to receive the input air pressure level from the input air pressure sensor 224. The output of the buffer amplifier 254 is fed to the A/D board 216 for wireless transmission to the portable control device 104. The portable control device 104 uses this information to display the “yard” air pressure level to a user of the portable control device 104.

The output of the buffer amplifier 254 is also fed to a peak detector 256. The peak detector 256 keeps track of the highest received input air pressure level. For example, as the source of compressed air 108 charges the air brake line, the input air pressure may be ninety PSI. If ninety PSI is as high as the input air pressure level reaches, then the peak detector 256 will hold the ninety PSI level as the peak input level. The pressure sensor interface 222 comprises a comparator 258 that receives the peak input level and the current measurement of the input pressure level. If the current measurement of the input pressure level drops too far below the peak input level, then the comparator 258 returns a positive signal and the pressure sensor interface 222 applies the positive signal to the emergency close valve node 244 of the valve motor drive 236 (FIG. 6) associated with the main valve 206. The positive signal on the emergency close valve node 244 serves to move the main valve 206 to a position that prevents airflow from the air brake line from flowing out the input air line towards the source of compressed air 108. This emergency close valve mechanism serves to prevent the air brake line from losing much air pressure if the air pressure in the input air line suddenly drops while the main valve 206 is in a position that allows airflow between the air brake line and the input air line.

The pressure sensor interface 222 comprises a buffer amplifier 260, such as a unity gain buffer, to receive the exit air pressure level from the exit air pressure sensor 226. The output of the buffer amplifier 260 is fed to the A/D board 216 for wireless transmission to the portable control device 104. The portable control device 104 uses this information to display the air pressure level in the air brake line of the train consist 106 to a user of the portable control device 104.

The portable control device 104 is adapted to remotely control the airflow manipulating device 102 to perform an air pressure reduction test of the air brake line. The air pressure reduction test serves to reduce the air pressure level in the air brake line by a set reduction amount. The pressure sensor interface 222 comprises a summation amplifier 262 that receives the peak input level and a reference voltage that corresponds to the set reduction amount (such as twenty PSI). The output of the summation amplifier 262 is the peak input level less the set reduction amount. In one example, the peak input level is ninety PSI and the set reduction amount is twenty PSI. In that case, the output of the summation amplifier is a reference signal that represents seventy PSI. The pressure sensor interface 222 comprises a comparator 264 that receives the output of the summation amplifier 262 and the current measurement of the air pressure level in the air brake line.

If the current measurement of the air pressure level in the air brake line drops too far below the air pressure level that corresponds to the output of the summation amplifier 262 (e.g., seventy PSI), then the comparator 258 returns a positive signal and the pressure sensor interface 222 applies the positive signal to the emergency close valve node 244 of the valve motor drive 236 (FIG. 6) associated with the reduction valve 208. The positive signal on the emergency close valve node 244 serves to move the reduction valve 208 to a position that prevents a further release of air from the air brake line. This emergency close valve mechanism serves to prevent the air brake line from losing much air pressure if the portable control device 104 fails to send a control signal to close the reduction valve 208 after the air pressure level in the air brake line has been reduced by the set reduction amount (such as twenty PSI).

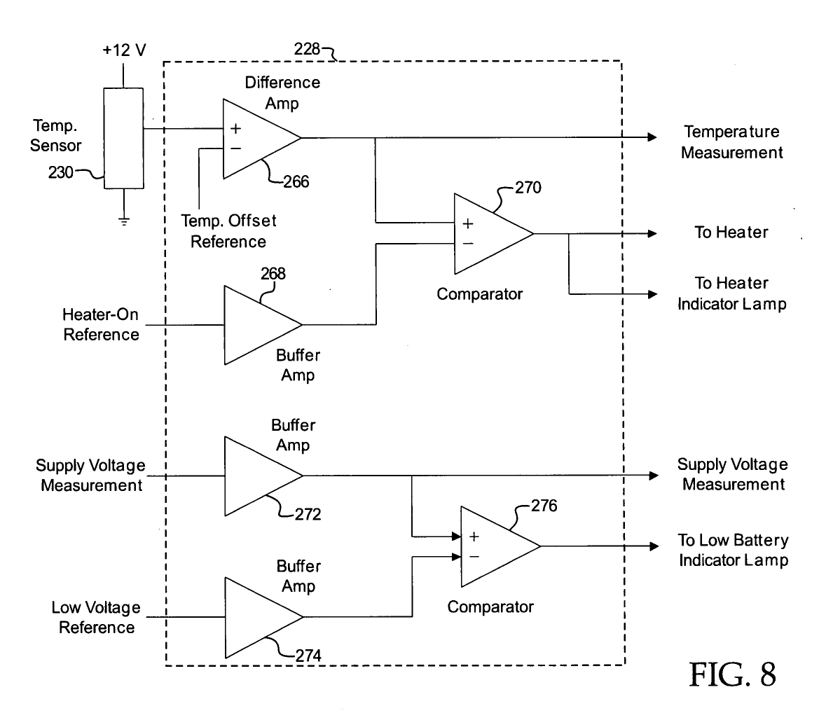

Referring to FIGS. 5 and 8, an illustrative description of one operation of the temperature and voltage interface 228 is now presented, for explanatory purposes. The temperature sensor 230 measures the temperature level inside the housing of the airflow manipulating device 102. The temperature and voltage interface 228 receives the temperature level from the temperature sensor 230. The temperature and voltage interface 228 comprises a difference amplifier 266 to receive the temperature level and a temperature offset reference. The output of the difference amplifier 266 is fed to the A/D board 216 for wireless transmission to the portable control device 104. The portable control device 104 uses this information to display the temperature level in the housing of the airflow manipulating device 102 to a user of the portable control device 104.

The temperature and voltage interface 228 comprises a comparator 270 to receive the output of the difference amplifier 266 and a heater-on reference signal from a buffer amplifier 268. The heater-on reference signal corresponds to a predetermined temperature level. When the measured temperature level output from the difference amplifier 266 falls below the predetermined temperature level, the comparator 270 outputs a signal to turn on a heater inside the housing of the airflow manipulating device 102. The comparator 270 also outputs a signal that activates an indication that the heater is operating. The heater serves to warm up the components inside the housing that may not be rated for use below the predetermined temperature level.

The airflow manipulation device 102 comprises a battery that provides power to one or more components of the airflow manipulation device 102. A battery sensor in one example measures a battery supply level of the battery. The temperature and voltage interface 228 comprises a buffer amplifier 272 to receive the battery supply level measurement. The buffer amplifier 272 outputs the battery supply level measurement to the A/D board 216 for wireless transmission to the portable control device 104. The portable control device 104 uses this information to display a batter supply level of the battery in the airflow manipulating device 102 to a user of the portable control device 104.

The temperature and voltage interface 228 comprises a comparator 270 to receive the battery supply level measurement and a low voltage reference signal from a buffer amplifier 274. The low voltage reference signal corresponds to a predetermined voltage level that indicates that the battery may need to be replaced. When the battery supply level measurement falls below the low voltage reference level, the comparator 276 outputs a signal to indicate the low battery level in the airflow manipulating device 102. The low battery indication may be displayed on an exterior of the airflow manipulating device 102 and/or on a display of the portable control device 104.

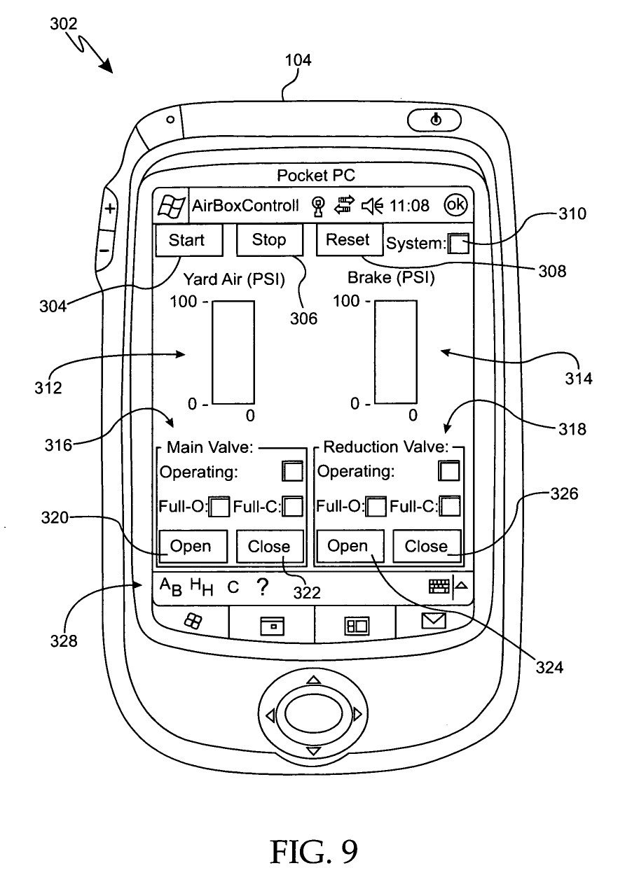

Referring to FIGS. 9-13, the portable control device 104 serves to remotely control the airflow manipulating device 102 (FIG. 1) to control the air pressure level in the air brake line of the train consist 106. The portable control device 104 is transportable by a user along the train consist 106 during inspection of the air brake line of the train consist 106. In one example, the portable control device 104 serves to instruct the airflow manipulating device 102 to allow air from the source of compressed air 108 to increase the air pressure level in the air brake line. In another example, the portable control device 104 serves to instruct the airflow manipulating device 102 to release air from the air brake line to perform an air pressure reduction test of the air brake line. Furthermore, the portable control device 104 serves to allow a user to remotely monitor conditions of the airflow manipulating device 102 and the air brake line. The portable control device 104 allows the user to receive this information while the user is walking along the train consist 106 to inspect the air brake line. The portable control device 104 in one example receives measurements of the air pressure level in the air brake line. The portable control device 104 can use these measurements to monitor an amount of air pressure leakage in the air brake line. Upon determination that the amount of air pressure leakage in the air brake line over a period of time exceeds a predetermined amount, the portable control device 104 provides an excessive leakage indication to a user of the portable control device 104. The predetermined threshold leakage amount in one example is set to five PSI per minute, as stated in the Federal Railroad Administration regulations (49 CFR §232.12).

The portable control device 104 in one example comprises a handheld computer with a user interface. The user interface displays information to the user and allows the user to input commands to be performed by the portable control device 104. For example, the user interface may comprise a display screen and a user input device. The user input device may comprise touch screen buttons, traditional buttons, a keyboard, or the like. The portable control device 104 in one example comprises a data storage component. For example, the data storage component may store information related to the air pressure reduction and leakage tests of the air brake line, such as air pressure measurements at one or more points in the air pressure reduction test and whether the air brake line passed or failed the air pressure reduction and leakage tests. The information related to the air pressure reduction and leakage tests can later be transferred from the portable control device 104 to separate storage device or to a printer to create a record of the air pressure reduction and leakage tests.

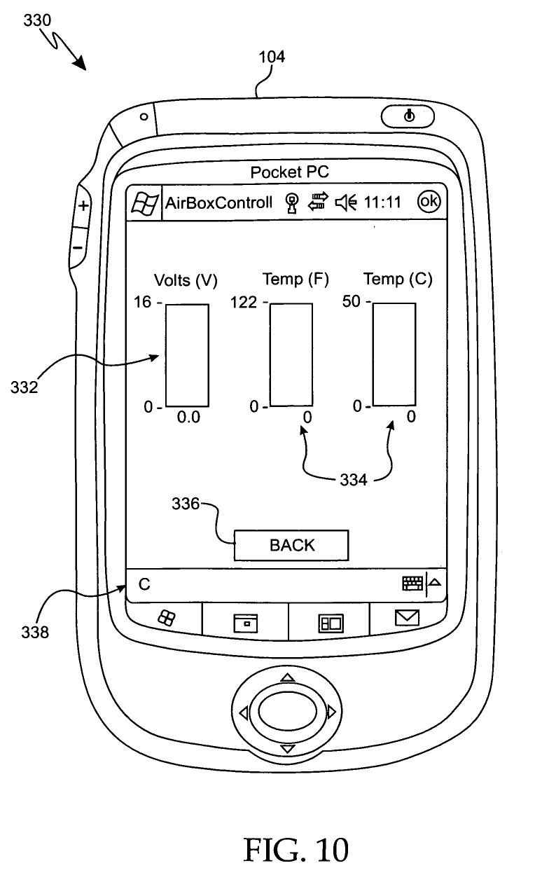

Referring to FIG. 9, the portable control device 104 is shown presenting a first display page 302. The first display page 302 in one example comprises a start button 304, a stop button 306, a reset button 308, a system operating indicator 310, an input air pressure gauge 312, a brake line air pressure gauge 314, a main valve position indicator 316, a reduction valve position indicator 318, an open main valve button 320, a close main valve button 322, an open reduction valve button 324, a close reduction valve button 326, and one or more buttons 328 for navigation to other display pages, such as the display pages of FIGS. 10-13.

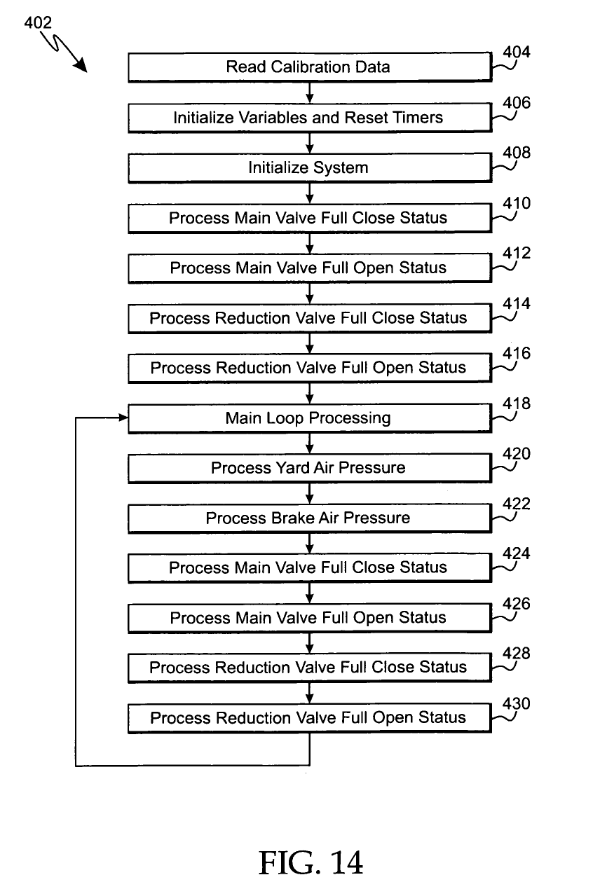

The start button 304 is used to initialize the system to set up communication between the portable control device 104 and the airflow manipulating device 102. The stop button 306 ends communication between the portable control device 104 and the airflow manipulating device 102. The reset button 308 re-initializes the system for communication between the portable control device 104 and the airflow manipulating device 102. The operation of the start button 304 and the reset button 308 is described below with reference to FIG. 14.

The portable control device 104 uses the system operating indicator 310 to show whether communication between the portable control device 104 and the airflow manipulating device 102 is operational. When the communication system becomes operational, the portable control device 104 changes the system operating indicator 310 to green. When the communication system becomes not operational, the portable control device 104 changes the system operating indicator 310 to red.

The input air pressure gauge 312 displays the air pressure level at an input to the airflow manipulating device 102 (e.g., the “yard” air pressure level). For example, airflow manipulating device 102 comprises an air pressure sensor that measures an air pressure level in the air line between the source of compressed air 108 and the main valve 206 in the airflow manipulating device 102. The airflow manipulating device 102 sends the measured input air pressure level to the portable control device 104. The portable control device 104 uses the input air pressure gauge 312 to display the measured input air pressure level to a user of the portable control device 104. As the portable control device 104 receives updates of the input air pressure level from the airflow manipulating device 102, the portable control device 104 updates the input air pressure gauge 312 to display the most current air pressure information.

The brake line air pressure gauge 314 displays the air pressure level in the air brake line. For example, airflow manipulating device 102 comprises an air pressure sensor that measures an air pressure level in the air line between the train consist 106 and the main valve 206 in the airflow manipulating device 102. The airflow manipulating device 102 sends the measured brake line air pressure level to the portable control device 104. The portable control device 104 uses the brake line air pressure gauge 314 to display the measured brake line air pressure level to a user of the portable control device 104. As the portable control device 104 receives updates of the brake line air pressure level from the airflow manipulating device 102, the portable control device 104 updates the brake line air pressure gauge 314 to display the most current air pressure information.

The main valve position indicator 316 indicates whether the main valve 206 is operating, fully open, or fully closed. For example, when the main valve 206 is operating, the portable control device 104 changes the “operating” indication to green. When the main valve 206 is not operating, the portable control device 104 changes the “operating” indication to red. If the main valve 206 is either fully open or fully closed, the portable control device 104 changes the appropriate indicator in the main valve position indicator 316 to green and the other to red. If the main valve 206 is neither fully open or fully closed, then the portable control device 104 changes both open/closed indicators in the main valve position indicator 316 to red. The reduction valve position indicator 318 operates the same way as the main valve position indicator 316, but for the reduction valve 208.

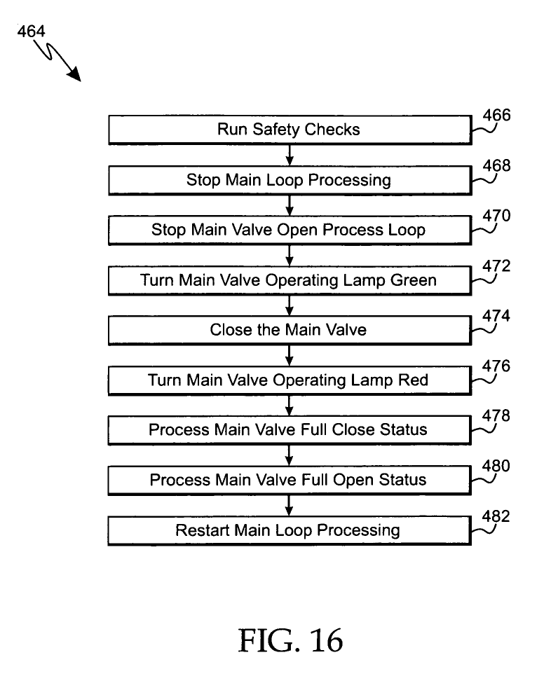

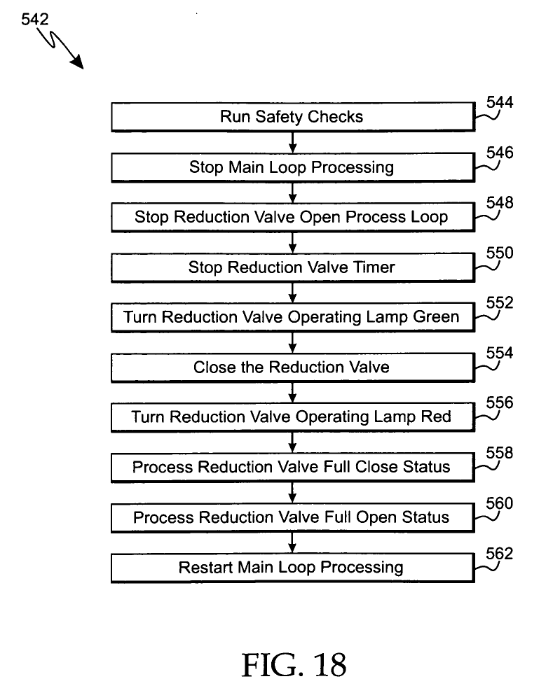

The user of the portable control device 104 uses the buttons 320, 322, 324, and 326 to control the positions of the main valve 206 and the reduction valve 208 in the airflow manipulating device 102. The operation of the open main valve button 320 is described below with reference to FIG. 15. The operation of the close main valve button 322 is described below with reference to FIG. 16. The operation of the open reduction valve button 324 is described below with reference to FIG. 17. The operation of the close reduction valve button 326 is described below with reference to FIG. 18.

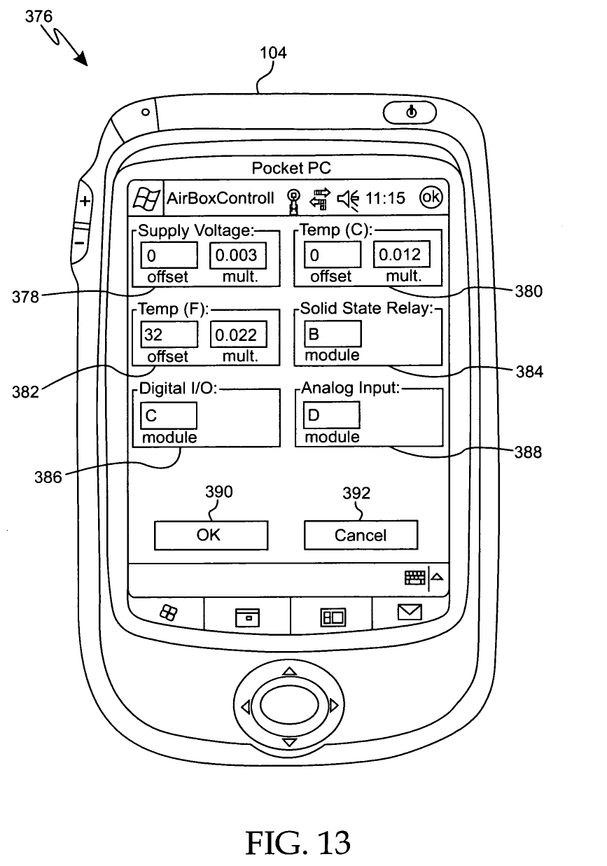

Referring to FIG. 10, the portable control device 104 is shown presenting a second display page 330. The second display page 330 in one example comprises a battery level gauge 332, temperature gauges 334, a button 336 that returns the portable control device 104 back to the first display page 302 (FIG. 9), and a button 338 for navigation to the display page of FIG. 13. The portable control device 104 periodically requests updated information from the airflow manipulating device 102 for the display page 330. For example, the portable control device 104 may send a request to the airflow manipulating device 102 every 650 milliseconds.

The airflow manipulation device 102 in one example comprises a battery that provides power to one or more components of the airflow manipulation device 102. The airflow manipulation device 102 measures and sends a battery supply level of the battery to the portable control device 104. The portable control device 104 uses the battery level gauge 332 to display the battery supply level to a user of the portable control device 104.

The components of the airflow manipulation device 102 in one example are stored within a housing. The airflow manipulation device 102 sends a temperature level measured inside the housing to the portable control device 104. The portable control device 104 uses the temperature gauges 334 to display the temperature level inside the housing of the airflow manipulation device 102 to a user of the portable control device 104. One of the temperature gauges 334 displays the temperature level in Fahrenheit and the other of the temperature gauges 334 displays the temperature level in Celsius.

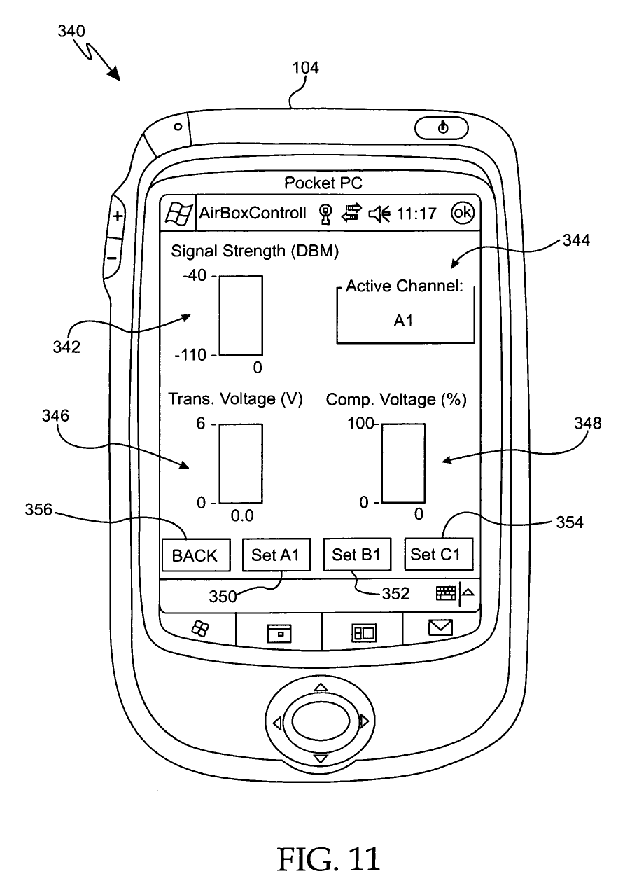

Referring to FIG. 11, the portable control device 104 is shown presenting a third display page 340. The third display page 340 in one example comprises a radio signal strength gauge 342, an active channel indicator 344, a transceiver battery level gauge 346, a portable control device battery level gauge 348, set active channel buttons 350, 352, and 354, and a button 356 that returns the portable control device 104 back to the first display page 302 (FIG. 9). The portable control device 104 periodically updates the information on the display page 340. For example, the portable control device 104 may update the information on the display page 340 every three seconds.

The portable control device 104 measures a radio signal strength level for wireless communications with the airflow manipulation device 102 or a repeater. The portable control device 104 uses the radio signal strength gauge 342 to display the radio signal strength level to a user of the portable control device 104. The user can view the radio signal strength gauge 342 to determine whether the signal is strong enough for communication with the airflow manipulation device 102. The user in one example may decide not to start an air pressure reduction test from a location where the radio signal strength level displayed by the radio signal strength gauge 342 is too low.

The portable control device 104 uses the active channel indicator 344 to display an indication of the channel that is currently being used for communication with the airflow manipulating device 102. In one example, each of the channels provides a different communication path between the portable control device 104 and the airflow manipulating device 102. The first channel (“A1”) may provide a direct communication path between the portable control device 104 and the airflow manipulating device 102. The second channel (“B1”) may provide a communication path through a repeater. The third channel (“C1”) may provide a communication path through two repeaters. The user of the portable control device 104 uses the set active channel buttons 350, 352, and 354 to select an active channel from the available channels. For example, if the user is moving with the portable control device 104 from an area that is relatively close to the airflow manipulating device 102 to an area that is relatively far from the airflow manipulating device 102, then the user may use one of the set active channel buttons 350, 352, and 354 to switch from the channel that provides a direct communication path to the channel that provides a communication path through the repeater.

The portable control device 104 uses the portable control device battery level gauge 348 to display a battery supply level of the portable control device 104 to a user of the portable control device 104. The transceiver associated with the portable control device 104 in one example comprises a separate battery. The portable control device 104 uses the transceiver battery level gauge 346 to display a battery supply level of the transceiver battery to a user of the portable control device 104.

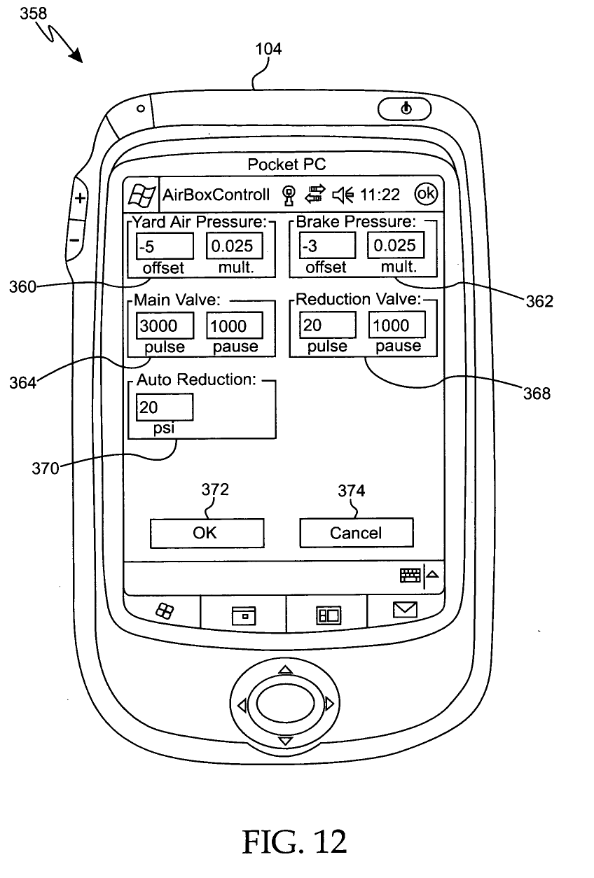

Referring to FIG. 12, the portable control device 104 is shown presenting a fourth display page 358. The fourth display page 358 in one example comprises an input air pressure measurement calibrator 360, a brake line air pressure measurement calibrator 362, main valve movement settings 364, reduction valve movement settings 368, an air pressure reduction amount setting 370, an accept changes button 372, and a cancel changes button 374.

The input air pressure measurement calibrator 360 serves to allow the user of the portable control device 104 to make adjustments to the offset and multiplier variables to calibrate the information received from the air pressure sensor that measures the air pressure level at the input of the airflow manipulating device 102. The brake line air pressure measurement calibrator 362 serves to allow the user of the portable control device 104 to make adjustments to the offset and multiplier variables to calibrate the information received from the air pressure sensor that measures the air pressure level in the air brake line.

The portable control device 104 serves to iteratively open the main valve 206 and the reduction valve 208. The valves are opened one “pulse” at a time, with a “pause” between each pulse. The longer the duration of the pulse, the more the valve is opened by each pulse. The pulse and pause values for the main valve 206 are adjustable from the portable control device 104 by changing the main valve movement settings 364. The pulse and pause values for the reduction valve 208 are adjustable from the portable control device 104 by changing the reduction valve movement settings 368.

When the user initiates an air pressure reduction test of the air brake line of the train consist 106, the portable control device 104 reduces the air pressure level of the air brake line by a predetermined amount. That predetermined amount is the valve stored in the air pressure reduction amount setting 370. Although the standard reduction amount for the air pressure reduction test of the air brake line is twenty PSI, the user can change the air pressure reduction amount setting 370 to perform an air pressure reduction test with a different reduction amount.

After any adjustments have been made on the display page 358, the user of the portable control device 104 can either accept the changes or cancel the changes. If the user wants to accept the changes, the user activates the accept changes button 372 and the portable control device 104 saves the new settings and returns to the display page 302 (FIG. 9). If the user wants to cancel the changes, the user activates the cancel changes button 374 and the portable control device 104 ignores the changes and returns to the display page 302.

Referring to FIG. 13, the portable control device 104 is shown presenting a fifth display page 376. The fifth display page 376 in one example comprises a battery level measurement calibrator 378, temperature measurement calibrators 380 and 382, module settings 384, 386, and 388, an accept changes button 390, and a cancel changes button 392.

The battery level measurement calibrator 378 serves to allow the user of the portable control device 104 to make adjustments to the offset and multiplier variables to calibrate the information received from sensor that measures the battery level of the battery in the airflow manipulating device 102. The temperature measurement calibrators 380 and 382 serve to allow the user of the portable control device 104 to make adjustments to the offset and multiplier variables to calibrate the information received from the temperature sensor that measures the temperature level in the housing of the airflow manipulating device 102.

The module settings 384, 386, and 388 serve to allow the user of the portable control device 104 to change the addressing of the A/D board 216, the I/O board 218, and the relay board 220 in the airflow manipulating device 102.

After any adjustments have been made on the display page 376, the user of the portable control device 104 can either accept the changes or cancel the changes. If the user wants to accept the changes, the user activates the accept changes button 390 and the portable control device 104 saves the new settings and returns to the display page 302 (FIG. 9). If the user wants to cancel the changes, the user activates the cancel changes button 392 and the portable control device 104 ignores the changes and returns to the display page 302.

Referring to FIG. 14, logic flow 402 illustrates an interaction between the portable control device 104 and the airflow manipulating device 102 to activate the system. The logic flow 402 starts in response to a system activation command entered by a user via the start button 304 or the reset button 308 (FIG. 9) of the portable control device 104. At STEP 404, the portable control device 104 reads the stored calibration data. At STEP 406, the portable control device 104 initializes all system variables and resets all system timers. At STEP 408, the portable control device 104 sends signals to the airflow manipulating device 102 to initialize the system. For example, the portable control device 104 sends initialization codes to the airflow manipulating device 102 to initialize the A/D board 216, the I/O board 218, and the relay board 220 (FIG. 5).

At STEPS 410 and 412, the portable control device 104 determines whether the main valve 206 (FIGS. 2-4) is either fully closed or fully open. To determine the current position of the main valve 206, the portable control device 104 sends a signal to the airflow manipulating device 102 to inquire whether the main valve 206 is either fully closed or fully open. The airflow manipulating device 102 responds with the current position of the main valve 206. If the response from the airflow manipulating device 102 indicates that the main valve 206 is fully closed, then the portable control device 104 uses the main valve position indicator 316 (FIG. 9) to indicate that the main valve 206 is fully closed. If the response from the airflow manipulating device 102 indicates that the main valve 206 is fully open, then the portable control device 104 uses the main valve position indicator 316 to indicate that the main valve 206 is fully open.

At STEPS 414 and 416, the portable control device 104 determines whether the reduction valve 208 (FIGS. 2-4) is either fully closed or fully open. To determine the current position of the reduction valve 208, the portable control device 104 sends a signal to the airflow manipulating device 102 to inquire whether the reduction valve 208 is either fully closed or fully open. The airflow manipulating device 102 responds with the current position of the reduction valve 208. If the response from the airflow manipulating device 102 indicates that the reduction valve 208 is fully closed, then the portable control device 104 uses the reduction valve position indicator 318 (FIG. 9) to indicate that the reduction valve 208 is fully closed. If the response from the airflow manipulating device 102 indicates that the reduction valve 208 is fully open, then the portable control device 104 uses the reduction valve position indicator 318 to indicate that the reduction valve 208 is fully open.

At STEP 418, the portable control device 104 begins the main loop processing. At STEP 420, the portable control device 104 determines the “yard” air pressure level. For example, the portable control device 104 sends a signal to the airflow manipulating device 102 to request the air pressure level in the air line between the source of compressed air 108 and the main valve 206 in the airflow manipulating device 102. The airflow manipulating device 102 responds with the current yard air pressure level. The portable control device 104 employs the input air pressure gauge 312 (FIG. 9) to display the current yard air pressure level. At STEP 422, the portable control device 104 determines the air pressure level in the air brake line of the train consist 106. For example, the portable control device 104 sends a signal to the airflow manipulating device 102 to request the air pressure level in the air line between the train consist 106 and the main valve 206 in the airflow manipulating device 102. The airflow manipulating device 102 responds with the current brake line air pressure level. The portable control device 104 employs the brake line air pressure gauge 314 (FIG. 9) to display the current brake line air pressure level.

At STEP 424, the portable control device 104 determines whether the main valve 206 is fully closed, as described in STEP 410. At STEP 426, the portable control device 104 determines whether the main valve 206 is fully open, as described in STEP 412. At STEP 428, the portable control device 104 determines whether the reduction valve 208 is fully closed, as described in STEP 414. At STEP 430, the portable control device 104 determines whether the reduction valve 208 is fully open, as described in STEP 416. Upon receipt of an indication that there has been a change in the fully open/close status of the main valve 206, the portable control device 104 changes the displayed status of the main valve 206 in the main valve position indicator 316 accordingly. Upon receipt of an indication that there has been a change in the fully open/close status of the reduction valve 208, the portable control device 104 changes the displayed status of the reduction valve 208 in the reduction valve position indicator 318 accordingly.

After the portable control device 104 determines the current positions of the main valve 206 and the reduction valve 208 in STEPS 424-430, the portable control device 104 proceeds back to STEP 418 to repeat the main loop processing. The portable control device 104 continues to run the main loop processing until interrupted by another function, such a user request to open or close a valve in the airflow manipulating device 102.

Referring to FIG. 15, logic flow 434 illustrates an interaction between the portable control device 104 and the airflow manipulating device 102 to open the main valve 206 (FIGS. 2-4) of the airflow manipulating device 102. Opening the main valve 206 allows air to flow between the source of compressed air 108 and the air brake line of the train consist 106. For example, when the main valve 206 is in the open position, the source of compressed air 108 serves to increase the air pressure level in the air brake line. The logic flow 434 starts in response to an open main valve command entered by a user via the open main valve button 320 (FIG. 9) of the portable control device 104.

At STEP 436, the portable control device 104 runs one or more safety checks before opening the main valve 206. In one example, the portable control device 104 checks whether the system is on and has been initialized. In another example, the portable control device 104 checks to make sure the main valve 206 is not already fully open. In yet another example, the portable control device 104 checks to make sure the reduction valve 208 is fully closed. After the safety checks have been satisfied in STEP 436, the portable control device 104 proceeds to STEP 438. At STEP 438, the portable control device 104 stops the main loop processing of STEPS 418-430 (FIG. 14). At STEP 440, the portable control device 104 determines the current yard air pressure level, as described in STEP 420 (FIG. 14). At STEP 442, the portable control device 104 displays an indication that the main valve 206 is operating. For example, the portable control device 104 changes the “operating” indication to green in the main valve position indicator 316 (FIG. 9).

At STEP 444, the portable control device 104 sends a control signal to the airflow manipulating device 102 to move the main valve 206. For example, the control signal in STEP 444 instructs the airflow manipulating device 102 to move the main valve 206 to the edge of being open (i.e., almost open) so that the main valve 206 is ready to be opened by a “pulse” from a subsequent control signal sent by the portable control device 104. The control signal in STEP 444 in one example instructs the airflow manipulating device 102 to turn the main valve 206 for 650 milliseconds. After the main valve 206 has been moved into the almost-open position, the portable control device 104 proceeds to STEP 446 where the portable control device 104 begins the main valve open process loop. The main valve open process loop serves to incrementally open the main valve 206 to control the rate of air pressure reduction in the air brake line. The train consist 106 in one example “dumps” all air pressure in the air brake line if the air pressure level in the air brake line drops too quickly. The portable control device 104 incrementally opens the main valve 206 to prevent the train consist 106 from “dumping” all air pressure in the air brake line when the main valve 206 is opened. At STEP 448, the portable control device 104 determines the yard air pressure level, as described in STEP 420 (FIG. 14). At STEP 450, the portable control device 104 determines whether the main valve 206 is fully open, as described in STEP 412 (FIG. 14).

If the portable control device 104 determines that the main valve 206 is fully open at STEP 452, then the portable control device 104 proceeds to STEP 454. At STEP 454, the portable control device 104 stops the main valve open process loop. At STEP 456, the portable control device 104 updates the main valve position indicator 316 to indicate that the main valve 206 is no longer operating. For example, the portable control device 104 changes the “operating” indication to red in the main valve position indicator 316. Now that the main valve open function is complete, the portable control device 104 can resume the main loop processing. At STEP 458, the portable control device 104 restarts the main loop processing of STEPS 418-430 (FIG. 14).

If the portable control device 104 determines that the main valve 206 is not fully open at STEP 452, then the portable control device 104 proceeds to STEP 460. At STEP 460, the portable control device 104 determines whether the yard air pressure reduction rate is below a predetermined rate. The predetermined rate is set at a level to prevent the train consist 106 from “dumping” all air pressure in the air brake line when the main valve 206 is opened. The predetermined rate in one example is set to one PSI per second. Based on the yard air pressure level measurements received from the airflow manipulating device 102, the portable control device 104 determines whether the yard air pressure level is dropping faster than the predetermined rate. If the yard air pressure level is dropping faster than the predetermined rate allows, then STEP 460 proceeds back to STEP 446 without further opening the main valve 206. If the air pressure level is dropping slower than the predetermined rate allows, then STEP 460 proceeds to STEP 462. At STEP 462, the portable control device 104 sends a control signal to the airflow manipulating device 102 to open the main valve 206 by one “pulse.” The control signal in STEP 462 in one example instructs the airflow manipulating device 102 to turn the main valve 206 for 3000 milliseconds. The amount that each pulse opens the main valve 206 is adjustable from the portable control device 104 by changing the main valve movement settings 364 (FIG. 12). After the main valve 206 has been moved by one pulse in STEP 462, STEP 462 proceeds back to STEP 446. The main valve open process loop at STEP 446 repeats after waiting a predetermined “pause” period. The pause period in one example makes the portable control device 104 wait for 1000 milliseconds before continuing. The length of the pause period is adjustable from the portable control device 104 by changing the main valve movement settings 364. The main valve open process loop serves to incrementally open the main valve 206 one “pulse” at a time until the main valve 206 is fully open.

Referring to FIG. 16, logic flow 464 illustrates an interaction between the portable control device 104 and the airflow manipulating device 102 to close the main valve 206 (FIGS. 2-4). Closing the main valve 206 prevents air from flowing between the source of compressed air 108 and the air brake line of the train consist 106. Also, when in the closed position, the main valve 206 allows air from the air brake line of the train consist 106 to reach the reduction valve 208 (FIGS. 2-4). The logic flow 464 starts in response to a close main valve command entered by a user via the close main valve button 322 (FIG. 9) of the portable control device 104.

At STEP 466, the portable control device 104 runs one or more safety checks before closing the main valve 206. In one example, the portable control device 104 checks whether the system is on and has been initialized. In another example, the portable control device 104 checks to make sure the main valve 206 is not already fully closed. After the safety checks have been satisfied at STEP 466, the portable control device 104 proceeds to STEP 468. At STEP 468, the portable control device 104 stops the main loop processing of STEPS 418-430 (FIG. 14). At STEP 470, the portable control device 104 stops the main valve open function if it was in progress when the main valve close command was entered. At STEP 472, the portable control device 104 displays an indication that the main valve 206 is operating. For example, the portable control device 104 changes the “operating” indication to green in the main valve position indicator 316 (FIG. 9). At STEP 474, the portable control device 104 sends a control signal to the airflow manipulating device 102 to fully close the main valve 206.

At STEP 476, the portable control device 104 updates the main valve position indicator 316 to indicate that the main valve 206 is no longer operating. For example, the portable control device 104 changes the “operating” indication to red in the main valve position indicator 316. At STEPS 478 and 480, the portable control device 104 determines whether the main valve 206 is either fully open or closed, as described in STEPS 410 and 412. Now that the main valve close function is complete, the portable control device 104 can resume the main loop processing. At STEP 482, the portable control device 104 restarts the main loop processing of STEPS 418-430 (FIG. 14).

Referring to FIG. 17, logic flow 502 illustrates one exemplary interaction between the portable control device 104 and the airflow manipulating device 102 to open the reduction valve 208 (FIGS. 2-4). Opening the reduction valve 208 allows air from the air brake line of the train consist 106 to exit through the reduction orifice 210 (FIGS. 2-4). The logic flow 502 starts in response to an open reduction valve command entered by a user via the open reduction valve button 324 (FIG. 9) of the portable control device 104.

At STEP 504, the portable control device 104 runs one or more safety checks before opening the reduction valve 208. In one example, the portable control device 104 checks whether the system is on and has been initialized. In another example, the portable control device 104 checks to make sure the reduction valve 208 is not already fully open. In yet another example, the portable control device 104 checks to make sure the main valve 206 is fully closed. After the safety checks have been satisfied at STEP 504, the portable control device 104 proceeds to STEP 506. At STEP 506, the portable control device 104 determines the air pressure level in the air brake line for the train consist 106, as described in STEP 422 (FIG. 14). At STEP 508, the portable control device 104 stops the main loop processing of STEPS 418-430 (FIG. 14). At STEP 510, the portable control device 104 displays an indication that the reduction valve 208 is operating. For example, the portable control device 104 changes the “operating” indication to green in the reduction valve position indicator 318 (FIG. 9).

At STEP 512, the portable control device 104 sends a control signal to the airflow manipulating device 102 to move the reduction valve 208. For example, the control signal in STEP 512 instructs the airflow manipulating device 102 to move the reduction valve 208 to the edge of being open (i.e., almost open) so that the reduction valve 208 is ready to be opened by a subsequent control signal from the portable control device 104. The control signal in STEP 512 in one example turns the reduction valve 208 for 730 milliseconds. After the reduction valve 208 has been moved into the almost-open position, the portable control device 104 proceeds to STEP 514. At STEP 514, the portable control device 104 starts a reduction valve timer. At STEP 516, the portable control device 104 begins the reduction valve open process loop. The reduction valve open process loop serves to incrementally open the reduction valve 208 to control the rate of air pressure reduction in the air brake line. The train consist 106 in one example “dumps” all air pressure in the air brake line if the air pressure level in the air brake line drops too quickly. The portable control device 104 incrementally opens the reduction valve 208 to prevent the train consist 106 from “dumping” all air pressure in the air brake line when the reduction valve 208 is opened.

At STEP 518, the portable control device 104 determines the air pressure level in the air brake line for the train consist 106, as described in STEP 422. At STEPS 520 and 522, the portable control device 104 determines whether the reduction valve 208 is either fully closed of fully open, as described in STEPS 414 and 416 (FIG. 14).

At STEP 524, the portable control device 104 determines whether the goal reduction setting was met in the air brake line of the train consist 106. The goal reduction setting in one example is adjustable from the portable control device 104 by changing the air pressure reduction amount setting 370 (FIG. 12). The standard reduction amount for the air pressure reduction test of the air brake line is twenty PSI. If the air pressure level in the air brake line was ninety PSI before initiation of the air pressure reduction test, then the goal reduction is met when the air brake line has been reduced to seventy PSI.

If the goal reduction is met at STEP 524, then the portable control device 104 proceeds to STEP 526. At STEP 526, the portable control device 104 stops the reduction valve open process loop. At STEP 528, the portable control device 104 stops the reduction valve timer. At STEP 530, the portable control device 104 fully closes the reduction valve 208. At STEP 532, the portable control device 104 changes the “operating” indication to red in the reduction valve position indicator 318 after the reduction valve 208 has been fully closed. Now that the reduction valve open function is complete, the portable control device 104 can resume the main loop processing. At STEP 534, the portable control device 104 restarts the main loop processing of STEPS 418-430 (FIG. 14).

If the goal reduction is not met at STEP 524, then the portable control device 104 proceeds to STEP 536. At STEP 536, the portable control device 104 determines whether the brake air pressure reduction rate is below a predetermined rate. The predetermined rate is set at a level to prevent the train consist 106 from “dumping” all air pressure in the air brake line when the reduction valve 208 is opened. The predetermined rate in one example is one PSI per second. Based on the brake air pressure level measurements received from the airflow manipulating device 102, the portable control device 104 determines whether the brake line air pressure level is dropping faster than the predetermined rate. If the brake line air pressure level is dropping faster than the predetermined rate allows, then STEP 536 proceeds to STEP 540 without further opening the reduction valve 208. If the air pressure level is dropping slower than the predetermined rate allows, then STEP 536 proceeds to STEP 538. At STEP 538, the portable control device 104 sends a control signal to the airflow manipulating device 102 to open the reduction valve 208 by one “pulse.” The control signal in STEP 538 in one example turns the reduction valve 208 for twenty milliseconds. The amount that each pulse opens the reduction valve 208 is adjustable from the portable control device 104 by changing the reduction valve movement settings 368 (FIG. 12). After the reduction valve 208 has been moved by one pulse in STEP 538, STEP 538 proceeds to STEP 540. At STEP 540, the portable control device 104 determines whether the reduction valve timer set at STEP 514 has expired. The reduction valve timer is set to limit the amount of time the reduction valve 208 is left open. The reduction valve timer in one example is set to 520 seconds. If the reduction timer has expired at STEP 540, then the portable control device 104 proceeds to STEP 526 where the reduction valve open process loop is stopped. If the reduction timer has not expired at STEP 540, then the portable control device 104 proceeds back to STEP 516 for another iteration of the reduction valve open process loop. The reduction valve open process loop at 516 repeats after waiting a predetermined “pause” period. The pause period in one example makes the portable control device 104 wait for 1000 milliseconds before continuing. The length of the pause period is adjustable from the portable control device 104 by changing the reduction valve movement settings 368. The reduction valve open process loop serves to incrementally open the reduction valve 208 one “pulse” at a time until the reduction valve 208 is either fully open, the predetermined reduction rate is reached, or the predetermined total reduction amount is reached.

Referring to FIG. 18, logic flow 542 illustrates one exemplary interaction between the portable control device 104 and the airflow manipulating device 102 to close the reduction valve 208 (FIGS. 2-4). Closing the reduction valve 208 prevents air from the air brake line of the train consist 106 from exiting through the reduction orifice 210 (FIGS. 2-4). The logic flow 542 starts in response to a close reduction valve command entered by a user via the close reduction valve button 326 (FIG. 9) of the portable control device 104.

At STEP 544, the portable control device 104 runs one or more safety checks before closing the reduction valve 208. In one example, the portable control device 104 checks whether the system is on and has been initialized. In another example, the portable control device 104 checks to make sure the reduction valve 208 is not already fully closed. In yet another example, the portable control device 104 checks to make sure the main valve 206 is fully closed. After the safety checks have been satisfied at STEP 544, the portable control device 104 proceeds to STEP 546. At STEP 546, the portable control device 104 stops the main loop processing of STEPS 418-430 (FIG. 14). At STEP 548, if the reduction valve 208 is in the process of being opened, the portable control device 104 stops the reduction valve open process loop. At STEP 550, the portable control device 104 stops the reduction valve timer that was started at STEP 514 (FIG. 17). At STEP 552, the portable control device 104 displays an indication that the reduction valve 208 is operating. For example, the portable control device 104 changes the “operating” indication to green in the reduction valve position indicator 318 (FIG. 9).

At STEP 554, the portable control device 104 sends a control signal to the airflow manipulating device 102 to fully close the reduction valve 208. The control signal in STEP 462 in one example turns the reduction valve 208 for 3000 milliseconds to close the reduction valve 208. At STEP 556, the portable control device 104 changes the “operating” indication to red in the reduction valve position indicator 318 after the reduction valve 208 has been fully closed. At STEPS 558 and 560, the portable control device 104 determines whether the reduction valve 208 is either fully closed or open, as described in STEPS 414 and 416. Now that the reduction valve close function is complete, the portable control device 104 can resume the main loop processing. At STEP 562, the portable control device 104 restarts the main loop processing of STEPS 418-430 (FIG. 14).

Referring to FIG. 1, in addition to remotely controlling and monitoring the air pressure level in the air brake line of the train consist 106, the portable control device 104 can remotely control and monitor other functions in the rail yard. For example, the portable control device 104 could control yard lighting, track switching, hazard alerting, bridge control, and the like.

The system 100 in one example comprises a plurality of components such as one or more of electronic components, hardware components, and computer software components. A number of such components can be combined or divided in the system 100. The portable control device 104 of the system 100 employs and/or comprises a set and/or series of computer instructions written in or implemented with any of a number of programming languages, as will be appreciated by those skilled in the art.

The system 100 in one example employs one or more computer-readable signal-bearing media. The computer-readable signal-bearing media store software, firmware and/or assembly language for performing one or more portions of one or more implementations of the invention. Examples of a computer-readable signal-bearing medium for the system 100 comprise the recordable data storage medium of the portable control device 104. The computer-readable signal-bearing medium for the system 100 in one example comprise one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory. In another example, the computer-readable signal-bearing medium comprises a modulated carrier signal transmitted over a network comprising or coupled with the apparatus 100, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A system, comprising:
an airflow manipulating device disposed between a source of compressed air and an air brake line of a train consist;
a portable control device in wireless communication with the airflow manipulating device, wherein the portable control device is transportable by a user along the train consist during inspection of the air brake line, wherein the portable control device is adapted to transmit a control signal over a wireless communication channel to move a valve in the airflow manipulating device to a position that causes an increase or decrease of air pressure in the air brake line; and
an air pressure sensor that measures an air pressure level in the air brake line for wireless transmission to the portable control device.

2. The system of claim 1, wherein the portable control device remotely controls the airflow manipulating device to perform an air pressure reduction test of the air brake line;
wherein the portable control device initiates the air pressure reduction test by transmitting a first control signal over the wireless communication channel to the airflow manipulating device to move the valve into a position that allows a release of air pressure from the air brake line.

3. The system of claim 2, wherein the portable control device periodically receives indications of the air pressure level in the air brake line from the air pressure sensor during the air pressure reduction test;
wherein the portable control device transmits a second control signal over the wireless communication channel to the airflow manipulating device to close the valve after determination that the air pressure level in the air brake line has been reduced by a predetermined amount.

4. The system of claim 1, wherein the portable control device remotely controls the airflow manipulating device to perform an air pressure reduction test of the air brake line, wherein the air pressure reduction test serves to reduce the air pressure level in the air brake line by a set reduction amount, wherein the set reduction amount is adjustable from the portable control device.

5. The system of claim 1, wherein the portable control device remotely controls the airflow manipulating device to perform an air pressure reduction test of the air brake line, wherein the air pressure reduction test serves to determine whether air brakes of each car in the train consist apply in response to a twenty pound air pressure reduction in the air brake line;
wherein the user carries the portable control device along the train consist to remotely control the airflow manipulating device and receive data from the airflow manipulating device during inspection of the air brake line.

6. The system of claim 1, wherein the portable control device measures an amount of air pressure leakage in the air brake line;
wherein the portable control device provides an excessive leakage indication upon determination that the amount of air pressure leakage in the air brake line over a period of time exceeds a predetermined amount.

7. The system of claim 1, wherein the portable control device remotely controls the airflow manipulating device to perform an air pressure reduction test of the air brake line, wherein the portable control device comprises a data storage component for storage of information related to the air pressure reduction test.

8. The system of claim 1, wherein the airflow manipulating device comprises a main valve and a reduction valve, wherein the main valve is disposed between the source of compressed air and the air brake line, wherein the reduction valve is disposed between the main valve and a reduction orifice.

9. The system of claim 8, wherein to cause an increase of air pressure in the air brake line, the portable control device transmits a control signal over the wireless communication channel to the airflow manipulating device to move the main valve into a position that allows the source of compressed air to fill the air brake line with air.

10. The system of claim 8, wherein the portable control device is adapted to transmit a control signal over the wireless communication channel to the airflow manipulating device to move the main valve into a position that prevents air from the source of compressed air from reaching the air brake line and allows air from the air brake line to reach the reduction valve.

11. The system of claim 8, wherein to cause a decrease of air pressure in the air brake line, the portable control device transmits a control signal over the wireless communication channel to the airflow manipulating device to move the reduction valve into a position that allows a release of air from the air brake line out the reduction orifice.

12. The system of claim 1, wherein the portable control device remotely controls the airflow manipulating device to perform an air pressure reduction test of the air brake line, wherein the portable control device transmits control signals over the wireless communication channel to the airflow manipulating device to incrementally open the valve to achieve a desired rate of air pressure reduction in the air brake line for the air pressure reduction test;
wherein the portable control device stops transmitting the control signals that incrementally open the valve after determination that a rate of air pressure reduction in the air brake line meets or exceeds a predetermined rate of air pressure reduction.

13. The system of claim 12, wherein each of the control signals serves to open the valve, wherein the portable control device measures a rate of air pressure reduction in the air brake line after transmission of a control signal that incrementally opens the valve to determine whether to transmit an additional control signal to further open the valve;
wherein the portable control device transmits the additional control signal to further open the valve when the measured rate of air pressure reduction in the air brake line is below the predetermined rate of air pressure reduction.

14. The system of claim 12, wherein each of the control signals serves to open the valve by a set amount, wherein each of the control signals are separated by a set amount of time;
wherein the set amount to open the valve and the set amount of time between control signals are adjustable from the portable control device.

15. The system of claim 1, wherein the portable control device is adapted to transmit a first control signal over the wireless communication channel to the airflow manipulating device to move the valve into a partially open position that allows a release of air from the air brake line;
wherein the portable control device is adapted to transmit a second control signal over the wireless communication channel to the airflow manipulating device to further open the valve, provided that a rate of air pressure reduction in the air brake line, while the valve is in the partially open position, is below a predetermined rate of air pressure reduction.

16. The system of claim 1, wherein the wireless communication channel comprises a dedicated radio-frequency data channel.

17. The system of claim 1, further comprising a repeater that receives and forwards wireless transmissions between a transceiver associated with the portable control device and a transceiver associated with the airflow manipulating device.

18. The system of claim 17, wherein the portable control device transmits the control signal over a first wireless communication channel when direct transmission to the airflow manipulating device is selected by the user, wherein the portable control device transmits the control signal over a second wireless communication channel when transmission through the repeater to the airflow manipulating device is selected by the user.

19. The system of claim 1, wherein the airflow manipulation device transmits an acknowledgement message to the portable control device in response to a control signal received from the portable control device to indicate completion of a task associated with the control signal.

20. The system of claim 1, wherein the valve in the airflow manipulating device comprises a main valve disposed between the source of compressed air and the air brake line, wherein an input air line provides a path for airflow between the source of compressed air and the main valve;
wherein upon detection of a decrease in air pressure in the input air line while the main valve is in a position that allows airflow between the air brake line and the input air line, the airflow manipulating device moves the main valve to a position that prevents airflow from the air brake line to the input air line.

21. The system of claim 1, wherein the valve in the airflow manipulating device comprises a reduction valve that allows a release of air from the air brake line during an air pressure reduction test of the air brake line;
wherein upon detection that an air pressure level in the air brake line has reached a predetermined reduction level during the air pressure reduction test, the airflow manipulating device moves the reduction valve to a position that prevents a further release of air from the air brake line.

22. The system of claim 1, further comprising an air pressure sensor that measures an air pressure level in an input air line between the source of compressed air and the airflow manipulating device for radio transmission to the portable control device;
wherein the portable control device displays the air pressure level of the input air line and the air pressure level of the air brake line.

23. The system of claim 1, further comprising a temperature sensor and a heater inside a housing of the airflow manipulating device;
wherein the temperature sensor measures a temperature level inside the housing for wireless transmission to the portable control device;
wherein the heater is activated after the measured temperature level falls below a predetermined temperature level.

24. The system of claim 1, wherein the airflow manipulation device comprises a battery that provides power to one or more components of the airflow manipulation device, the system further comprising a battery sensor that measures a battery supply level of the battery for wireless transmission to the portable control device.

25. The system of claim 1, wherein the portable control device is adapted to measure and display a radio signal strength level for wireless communications with the airflow manipulation device or a repeater.

26. The system of claim 1, wherein the valve comprises an electronically actuated valve.

27. The system of claim 1, wherein the portable control device receives and displays an indication of a current position of the valve.

28. A system, comprising:
a portable control device for wireless communication with an airflow manipulating device disposed between a source of compressed air and an air brake line of a train consist, wherein the portable control device is transportable by a user along the train consist during inspection of the air brake line;
wherein the portable control device is adapted to transmit a control signal over a wireless communication channel to move a valve in the airflow manipulating device to a position that causes an increase or decrease of air pressure in the air brake line;
wherein the portable control device is adapted to receive and display a measurement of an air pressure level in the air brake line.

29. The system of claim 28, wherein the portable control device remotely controls the airflow manipulating device to perform an air pressure reduction test of the air brake line;
wherein the portable control device initiates the air pressure reduction test by transmitting a first control signal over the wireless communication channel to the airflow manipulating device to move the valve into a position that allows a release of air pressure from the air brake line;
wherein the portable control device periodically receives indications of the air pressure level in the air brake line from the air pressure sensor during the air pressure reduction test;
wherein the portable control device transmits a second control signal over the wireless communication channel to the airflow manipulating device to close the valve after determination that the air pressure level in the air brake line has been reduced by a predetermined amount.

30. The system of claim 28, wherein the portable control device remotely controls the airflow manipulating device to perform an air pressure reduction test of the air brake line, wherein the air pressure reduction test serves to determine whether air brakes of each car in the train consist apply in response to a twenty pound air pressure reduction in the air brake line;
wherein the user carries the portable control device along the train consist to remotely control the airflow manipulating device and receive data from the airflow manipulating device during inspection of the air brake line.

31. A system comprising:
a portable control device in communication with an airflow manipulating device over a wireless communication channel;
the airflow manipulating device disposed between a source of compressed air and an air brake line of a train consist, the airflow manipulating device comprising:
a valve responsive to a first control signal transmitted by the portable control device over the wireless communication channel to the airflow manipulating device, wherein the first control signal causes the valve to move into a partially open position that allows a release of air from the air brake line;
a pressure sensor that measures an air pressure level in the air brake line while the valve is in the partially open position; and
a sending device that transmits the air pressure level measurement over the wireless communication channel to the portable control device;
wherein the portable control device transmits a second control signal over the wireless communication channel to the airflow manipulating device to further open the valve, provided that a rate of air pressure reduction in the air brake line, while the valve is in the partially open position, is below a predetermined rate of air pressure reduction.

32. The system of claim 31, wherein the portable control device remotely controls the airflow manipulating device to perform an air pressure reduction test of the air brake line, wherein the portable control device transmits control signals over the wireless communication channel to the airflow manipulating device to incrementally open the valve to achieve a desired rate of air pressure reduction in the air brake line for the air pressure reduction test;
wherein the portable control device measures the rate of air pressure reduction in the air brake line after transmission of the first control signal that incrementally opens the valve to determine whether to transmit the second control signal to further open the valve.

33. The system of claim 31, wherein the first and second control signals each serve to open the valve by a set amount, wherein the first and second control signals are separated by a set amount of time;
wherein the set amount to open the valve and the set amount of time between the first and second control signals are adjustable from the portable control device.

34. A method comprising the steps of:
transmitting a first control signal over a wireless communication channel to move a valve into a partially open position to perform an air pressure reduction test of an air brake line of a train consist;
receiving an air pressure level measurement corresponding to an air pressure level in the air brake line while the valve is in the partially open position; and
transmitting a second control signal over the wireless communication channel to further open the valve, provided that a rate of air pressure reduction in the air brake line, while the valve is in the partially open position, is below a predetermined rate of air pressure reduction.

35. The method of claim 34, further comprising the steps of:
leaving the valve in the partially open position for the air pressure reduction test, provided that the rate of air pressure reduction in the air brake line, while the valve is in the partially open position, meets or exceeds the predetermined rate of air pressure reduction; and
transmitting a control signal over the wireless communication channel to close the valve after determination that the air pressure level in the air brake line has been reduced by a predetermined amount.
